(19) United States
(12) Patent Application Publication
(10) Pub. No.: US 2023/0151984 A1
(43) Pub. Date: May 18, 2023

(54) ELECTROSTATIC DUST COLLECTION APPARATUS AND AIR PURIFIER COMPRISING SUCH ELECTROSTATIC DUST COLLECTION APPARATUS

(71) Applicant: Rice Ear Ltd., Taoyuan City (TW)

(72) Inventor: Ying-Che SUNG, Taoyuan City (TW)

(21) Appl. No.: 17/987,386

(22) Filed: Nov. 15, 2022

(30) Foreign Application Priority Data
Nov. 17, 2021 (TW) 110142817

(51) Int. Cl. F24F 8/192; B03C 3/82; B03C 3/47; B03C 3/49

(52) U.S. Cl. CPC F24F 8/194; B03C 3/82; B03C 3/47; B03C 3/49

(57) ABSTRACT

An electrostatic dust collection apparatus and an air purifier including such the electrostatic dust collection apparatus are provided. The electrostatic dust collection apparatus of the invention includes a sheet collection electrode, an insulative bearing member and a plurality of discharge electrodes. A first surface of the sheet collection electrode faces and is parallel to a second surface of the insulative bearing member. A plurality of grooves are formed on and across the second surface of the insulative bearing member, and are parallel to one another. Each discharge electrode corresponds to one of the grooves, and is disposed in the corresponding groove. An air passage is defined between the sheet collection electrode and the insulative bearing member, and allows an air to be treated to pass through. The discharge electrodes charge a plurality of floating particles in the air to be treated. The sheet collection electrode collects the charged particles.

### CROSS-REFERENCE TO RELATED APPLICATION

This utility application claims priority to Taiwan Application Serial Number 110142817, filed Nov. 17, 2021, which is incorporated herein by reference.

### BACKGROUND OF THE INVENTION

### 1. Field of the Invention

The invention relates to an electrostatic dust collection apparatus and an air purifier including such electrostatic dust collection apparatus, and more in particular, to an electrostatic dust collection apparatus capable of preventing contamination of discharge electrodes and an air purifier including such electrostatic dust collection apparatus and being capable of being miniaturized easily.

### 2. Description of the Prior Art

The operation of a general electrostatic dust collection apparatus is to ionize the air to be treated by the principle of corona discharge, such that the suspended particles in the air to be treated are charged by the ion impact. The charged suspended particles move to the collection electrode and are removed from the air to be treated, so as to achieve the purpose of purifying the air to be treated.

But, the discharge electrode in the electrostatic dust collection apparatus of the prior art is disposed in the air passage, such that the discharge electrode will be adsorbed by the suspended particles in the air to be treated to gradually reduce the discharge efficiency of the discharge electrode. This results in that the particle interception rate of the electrostatic dust collection apparatus of the prior art will also gradually decrease.

Referring to TW patent issue no. 1579052, a prior art prior art of reducing contamination of discharge electrodes is disclosed. The prior art discloses a plate-shaped high voltage conductive unit, a plurality of needle-shaped discharge electrodes, and several insulative members. The insulative members are formed on the plate-shaped high voltage conductive unit, and are respectively located at different positions in the air flow direction. In the direction of air flow, the plurality of needle-shaped discharge electrodes are shielded by the insulative members. Because the insulative members can block the air to be treated from directly flowing to the needle-shaped discharge electrodes, an air stagnation area will occur around the needle-shaped discharge electrodes shielded by the insulative members. However, the insulative members disclosed by the prior art cannot shield all of the needle-shaped discharge electrodes. Moreover, the plate-shaped high voltage conductive unit and the plurality of needle-shaped discharge electrodes disclosed in the prior art are obviously expensive to manufacture.

In addition, the plate-shaped collection electrode in most of the electrostatic dust collection apparatus of the prior art only use one surface itself to collect charged suspended particles, and do not fully utilize the whole surface of the plate-shaped collection electrode, which is not beneficial to the miniaturization of the air purifier using the electrostatic dust collection apparatus of the prior art.

### SUMMARY OF THE INVENTION

Accordingly, one scope of the invention is to provide an electrostatic dust collection apparatus capable of preventing contamination of discharge electrodes and an air purifier including such electrostatic dust collection apparatus. The air purifier according to the invention utilizes the whole surface of the collection electrode, which is beneficial to its miniaturization.

An electrostatic dust collection apparatus according to a first preferred embodiment of the invention includes a sheet collection electrode, an insulative bearing member, a plurality of discharge electrodes and a high voltage device. The sheet collection electrode has a first surface formed into a plane or an arc surface. The insulative bearing member has a second surface and a plurality of grooves formed on the second surface. The plurality of grooves are formed across the second surface of the insulative bearing member. The plurality of grooves are parallel to one another. The insulative bearing member is disposed so that the second surface of the insulative bearing member faces and is parallel to the first surface of the sheet collection electrode. An air passage is defined between the sheet collection electrode and the insulative bearing member, and allows an air to be treated to pass through. Each discharge electrode corresponds to one of the grooves, and is disposed in the corresponding groove. The high voltage device has a ground terminal and a discharge terminal. The ground terminal of the high voltage device is electrically connected to the sheet collection electrode. The discharge terminal of the high voltage device is electrically connected to the plurality of discharge electrodes such that a potential difference exists between the sheet collection electrode and the plurality of discharge electrodes. The plurality of discharge electrodes charge a plurality of suspended particles in the air to be treated. The sheet collection electrode collects the plurality of charged suspended particles.

In one embodiment, a distance between two adjacent grooves in the plurality of grooves ranges from 1 mm to 20 mm.

In one embodiment, an included angle between the second surface of the insulative bearing member and a sidewall of each groove ranges from 90 degrees to 335 degrees.

An electrostatic dust collection apparatus according to a second preferred embodiment of the invention includes a sheet collection electrode, an insulative bearing member, a plurality of discharge electrodes and a high voltage device. The sheet collection electrode has a first surface formed into a plane or an arc surface. The insulative bearing member has a second surface, a third surface opposite to the second surface and a plurality of grooves formed on the third surface and a plurality of through holes formed on the second surface. The plurality of grooves are formed across the third surface of the insulative bearing member. The plurality of grooves are parallel to one another. The insulative bearing member is disposed so that the second surface of the insulative bearing member faces and is parallel to the first surface of the sheet collection electrode. Each through hole corresponds to one of the plurality of grooves, and communicates with the corresponding groove. An air passage is defined between the sheet collection electrode and the insulative bearing member, and allows an air to be treated to pass through. Each discharge electrode corresponds to one of the grooves, and is disposed in the corresponding groove. The high voltage device has a ground terminal and a discharge terminal. The ground terminal of the high voltage device is electrically connected to the sheet collection electrode. The discharge terminal of the high voltage device is electrically connected to the plurality of discharge electrodes such that a potential difference exists between the sheet collection electrode and the plurality of discharge electrodes. The plurality of discharge electrodes charge a plurality of suspended particles in the air to be treated. The sheet collection electrode collects the plurality of charged suspended particles.

In one embodiment, a distance between two adjacent grooves in the plurality of grooves ranges from 1 mm to 20 mm.

In one embodiment, an included angle between the second surface of the insulative bearing member and a sidewall of each groove ranges from 90 degrees to 335 degrees.

An air purifier according to a third preferred embodiment of the invention includes a tubular collection electrode, an insulative outer tubular bearing member, an insulative inner tubular bearing member, a connecting member, an outer discharge electrode, an inner discharge electrode, and a high voltage device. The tubular collection electrode has a first outer surface and a first inner surface. The insulative outer tubular bearing member has a second outer surface, a second inner surface, a first groove formed on the second outer surface and a plurality of through holes formed on the second inner surface. The first groove extending helically on the second outer surface of the insulative outer tubular bearing member. The tubular collection electrode is disposed in the insulative outer tubular bearing member so that the second inner surface of the insulative outer tubular bearing member faces and is parallel to the first outer surface of the tubular collection electrode. Each through hole communicates with the first groove. A first air passage is defined between the tubular collection electrode and the insulative outer tubular bearing member. The insulative inner tubular bearing member has a third outer surface and a second groove formed on the third outer surface. The second groove extending helically on the third outer surface of the insulative inner tubular bearing member. The insulative inner tubular bearing member is disposed in the tubular collection electrode so that the third outer surface of the insulative inner tubular bearing member faces and is parallel to the first inner surface of the tubular collection electrode. A second air passage is defined between the tubular collection electrode and the insulative inner tubular bearing member. The connecting member connects a first top of the insulative outer tubular bearing member and a second top of the insulative inner tubular bearing member such that a downstream of the first air passage communicates with an upstream of the second air passage. The first air passage and the second air passage allow an air to be treated to pass through. The outer discharge electrode is disposed in the first groove, and extends along the first groove. The inner discharge electrode is disposed in the second groove, and extends along the second groove. The high voltage device has a ground terminal and a discharge terminal. The ground terminal of the high voltage device is electrically connected to the tubular collection electrode. The discharge terminal of the high voltage device is respectively electrically connected to the outer discharge electrode and the inner discharge electrode such that a first potential difference exists between the tubular collection electrode and the outer discharge electrode, and a second potential difference exists between the tubular collection electrode and the inner discharge electrode. The outer discharge electrode and the inner discharge electrode charge a plurality of suspended particles in the air to be treated. The tubular collection electrode collects the plurality of charged suspended particles.

In one embodiment, a first distance between two adjacent first groove sections in the first groove ranges from 1 mm to 20 mm. A second distance between two adjacent second groove sections in the second groove ranges from 1 mm to 20 mm.

In one embodiment, a first included angle between the third outer surface and a first sidewall of the second groove ranges from 180 degrees to 270 degrees. A second included angle between the second inner surface and a second sidewall of each through hole ranges from 90 degrees to 335 degrees.

In one embodiment, the first top of the insulative outer tubular bearing member and the second top of insulative inner tubular bearing member can exhibit a circle, an ellipse, a rectangle, a triangle, a trapezoid, a polygon with more than 4 sides, a half circle, a half ellipse, or other geometric shape.

Distinguishable from the prior arts, the electrostatic dust collection apparatus according to the invention can prevent the contamination of the overall polarized electrode, and the overall manufacturing cost of the electrostatic dust collection apparatus is low. The air purifier according to the invention utilizes the whole surface of the collection electrode, which is beneficial to its miniaturization.

The advantage and spirit of the invention may be understood by the following recitations together with the appended drawings.

### BRIEF DESCRIPTION OF THE APPENDED DRAWINGS

FIG. 1 is a partial cross-sectional view and a functional block diagram of some devices of an electrostatic dust collection apparatus according to the first preferred embodiment of the invention.

FIG. 2 is a flow field simulation analysis diagram of an example of the electrostatic dust collection apparatus according to the first preferred embodiment of the invention.

FIG. 3 is a potential simulation analysis diagram of the example of the electrostatic dust collection apparatus according to the invention shown in FIG. 2.

FIG. 4 is a flow field simulation analysis diagram of another example of the electrostatic dust collection apparatus according to the first preferred embodiment of the invention.

FIG. 5 is a potential simulation analysis diagram of the example of the electrostatic dust collection apparatus according to the invention shown in FIG. 4.

FIG. 6 is a partial enlarged view of a flow field simulation analysis diagram of another example of the electrostatic dust collection apparatus according to the first preferred embodiment of the invention.

FIG. 7 is a partial cross-sectional view and a functional block diagram of some devices of an electrostatic dust collection apparatus according to the second preferred embodiment of the invention.

FIG. 8 is an explosive view of the members and devices of an air purifier according to the third preferred embodiment of the invention.

FIG. 9 is a cross-sectional view taken along line A-A of the air purifier shown in FIG. 8 after being assembled.

FIG. 10 is another cross-sectional view taken along line A-A of the air purifier shown in FIG. 8 after being assembled.

FIG. 11 is an explosive view of the members and devices of a modification of the air purifier according to the third preferred embodiment of the invention.

FIG. 12 is a photograph of the appearance of the discharge electrode of the electrostatic dust collection apparatus according to the invention after operating for 1000 hrs.

FIG. 13 is a photograph of the appearance of the discharge electrode of the electrostatic dust collection apparatus of the prior art in which the discharge electrode is disposed in the air passage after operating for 24 hrs.

### DETAILED DESCRIPTION OF THE INVENTION

Some preferred embodiments and practical applications of this present invention would be explained in the following paragraph, describing the characteristics, spirit, and advantages of the invention.

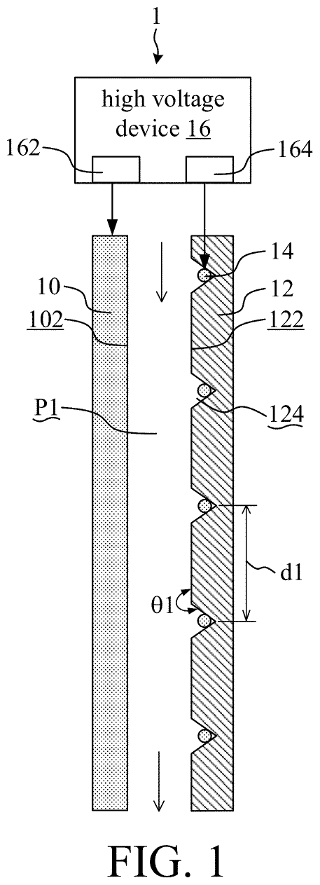

Referring to FIG. 1, FIG. 1 schematically shows an electrostatic dust collection apparatus 1 according to the first preferred embodiment of the invention with a partial cross-sectional view and a functional block diagram of some device.

As shown in FIG. 1, the electrostatic dust collection apparatus 1 according to the first preferred embodiment of the invention includes a sheet collection electrode 10, an insulative bearing member 12, a plurality of discharge electrodes 14 and a high voltage device 16.

The sheet collection electrode 10 has a first surface 102 formed into a plane or an arc surface. In the example shown in FIG. 1, the first surface 102 of the sheet collection electrode 10 is a plane.

The insulative bearing member 12 has a second surface 122 and a plurality of grooves 124 formed on the second surface 122. The plurality of grooves 124 are formed across the second surface 122 of the insulative bearing member 12. The plurality of grooves 124 are parallel to one another. The insulative bearing member 12 is disposed so that the second surface 122 of the insulative bearing member 12 faces and is parallel to the first surface 102 of the sheet collection electrode 10.

An air passage P1 is defined between the sheet collection electrode 10 and the insulative bearing member 12. The air passage P1 allows an air to be treated to pass through. In the example shown in FIG. 1, the air inlet of the air passage P1 is located at the top of the electrostatic dust collection apparatus 1 according to the invention, and the air outlet of the air passage P1 is located at the bottom of the electrostatic dust collection apparatus 1 according to the invention. The arrows marked in the air passage P1 represent the direction of air flow.

Each discharge electrode 14 corresponds to one of the grooves 124, and is disposed in the corresponding groove 124. In one embodiment, each discharge electrode 14 is a metal wire, e.g., stainless steel wire, copper wire, tungsten wire, etc. Compared with the electrostatic dust collection apparatus of the prior art, obviously, the electrostatic dust collection apparatus 1 according to the first preferred embodiment of the invention has a simple structure of the discharge electrode 14 and low manufacturing cost.

The high voltage device 16 has a ground terminal 162 and a discharge terminal 164. The ground terminal 162 of the high voltage device 16 is electrically connected to the sheet collection electrode 10. The discharge terminal 164 of the high voltage device 16 is electrically connected to the plurality of discharge electrodes 14 such that a potential difference exists between the sheet collection electrode 10 and the plurality of discharge electrodes 14. The plurality of discharge electrodes 14 charge a plurality of suspended particles in the air to be treated. The sheet collection electrode 10 collects the plurality of charged suspended particles. The electrostatic dust collection apparatus 1 according to the first preferred embodiment of the invention is created based on the boundary layer effect of fluid. Regarding the boundary layer effect of the fluid, the fluid is affected by the viscous force and will form a thin boundary layer at the edge of the device or member. Within the thin boundary layer, the flow velocity at the fixed surface is zero, and the flow velocity increases further from the edge of the device or member.

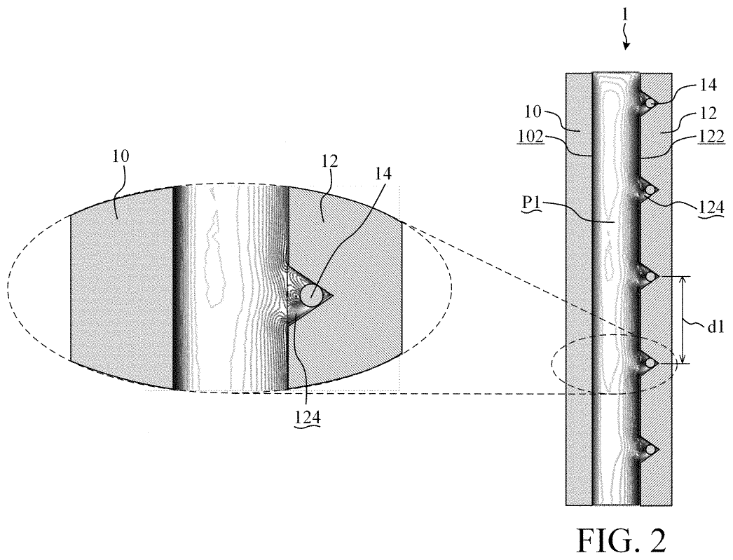

Referring to FIG. 2, FIG. 2 is a flow field simulation analysis diagram of an example of the electrostatic dust collection apparatus 1 according to the first preferred embodiment of the invention. In the flow field simulation analysis case of FIG. 2, the width of the air passage P1 is 5 mm. The enlarged view of the electrostatic dust collection apparatus 1 according to the invention is shown in FIG. 2 together and marked with an ellipse area with a dotted line. As shown in FIG. 2, the denser the streamline density in the air passage P1 represents the lower the flow velocity there. The flow field simulation analysis diagram of FIG. 2 confirms that the air flow in the grooves 124 of the insulative bearing member 12 is in a stagnant state. Thereby, the plurality of discharge electrodes 14 can reduce from being fouled by suspended particles.

In one embodiment, a distance d1 between two adjacent grooves 124 in the plurality of grooves 124 ranges from 1 mm to 20 mm. The distance d1 between two adjacent grooves 124 in the plurality of grooves 124 also represents the distance between two adjacent discharge electrodes 14 in the plurality of discharge electrodes 14. The smaller the distance d1 between the two adjacent grooves 124, the higher the distribution density of the discharge electrodes 14, and the increase of the spatial ionization region of the air passage P1.

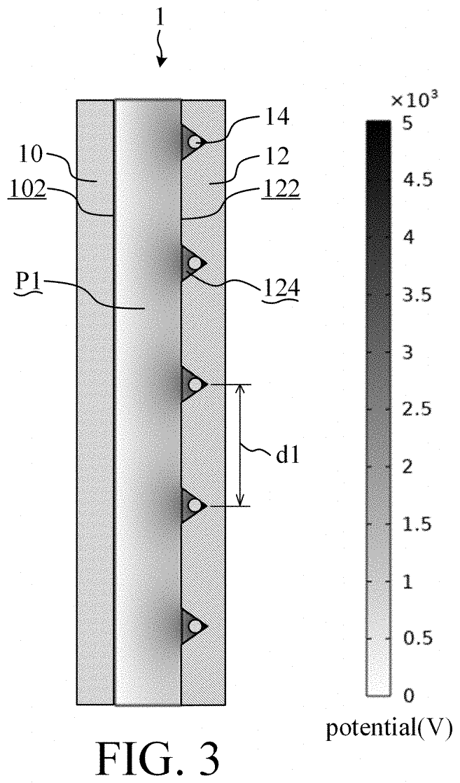

Referring to FIG. 3, FIG. 3 is a potential simulation analysis diagram of an example of the electrostatic dust collection apparatus 1 according to the invention shown in FIG. 2. Regarding the potential simulation analysis case in FIG. 3, the level of potential is represented by the level of gray scales, the plurality of discharge electrodes 14 are electrically connected to the high voltage device 16 of 5 kV, the distance d1 between two adjacent grooves 124 is 10 mm, and the flow velocity of the air is 2 m/s. The potential simulation analysis diagram of FIG. 3 confirms that the air flow in the grooves 124 of the insulative bearing member 12 is in a stagnant state. Thereby, the potential of the grooves 124 where the plurality of discharge electrodes 14 are located is the highest, and the potential of the first surface 102 of the sheet collection electrode 10 is 0 V as it is closer to the sheet collection electrode 10.

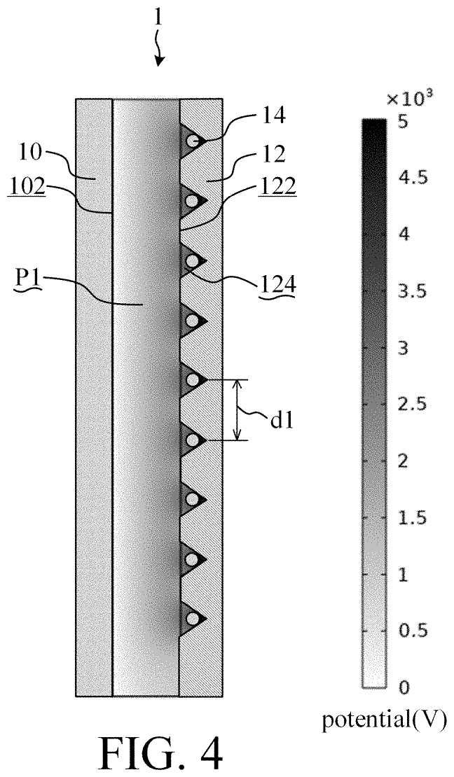

Referring to FIG. 4, FIG. 4 is a potential simulation analysis diagram of another example of the electrostatic dust collection apparatus 1 according to the invention. Regarding the potential simulation analysis case in FIG. 4, the level of potential is also represented by the level of gray scales, the plurality of discharge electrodes 14 are electrically connected to the high voltage device 16 of 5 kV, the distance d1 between two adjacent grooves 124 is 5 mm, and the flow velocity of the air is 2 m/s. Likewise, the potential simulation analysis diagram of FIG. 4 confirms that the air flow in the grooves 124 of the insulative bearing member 12 is in a stagnant state. Thereby, the potential of the grooves 124 where the plurality of discharge electrodes 14 are located is the highest, and the potential of the first surface 102 of the sheet collection electrode 10 is 0V as it is closer to the sheet collection electrode 10. But, compared to the example shown in FIG. 3, in FIG. 4, the distribution density of the discharge electrodes 14 is higher. Therefore, the potential simulation analysis diagram of FIG. 4 confirms that the potential of the region between the two adjacent grooves 124 is also quite high, which also represents an increase in the spatial ionization region of the air passage P1.

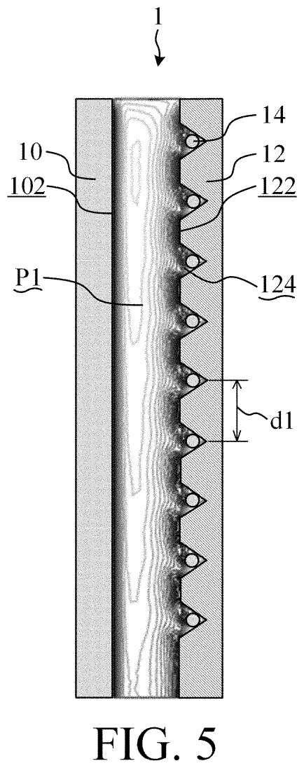

Referring to FIG. 5, FIG. 5 is a flow field simulation analysis diagram of the example of the electrostatic dust collection apparatus 1 according to the invention shown in FIG. 4. In the flow field simulation analysis case of FIG. 5, the width of the air passage P1 is 5 mm. It should be explained first that in the flow field simulation analysis diagram shown in FIG. 2, the distance d1 between two adjacent grooves 124 is 10 mm. In FIG. 5, the distance d1 between two adjacent grooves 124 is 5 mm. As shown in FIG. 5, the denser the streamline density in the air passage P1 represents the lower the flow velocity there. The flow field simulation analysis diagram of FIG. 5 confirms that the air flow in the grooves 124 of the insulative bearing member 12 is in a stagnant state. Thereby, the plurality of discharge electrodes 14 can reduce from being fouled by suspended particles.

In one embodiment, also as shown in FIG. 1, an included angle θ1 between the second surface 122 of the insulative bearing member 12 and a sidewall of each groove ranges from 90 degrees to 335 degrees.

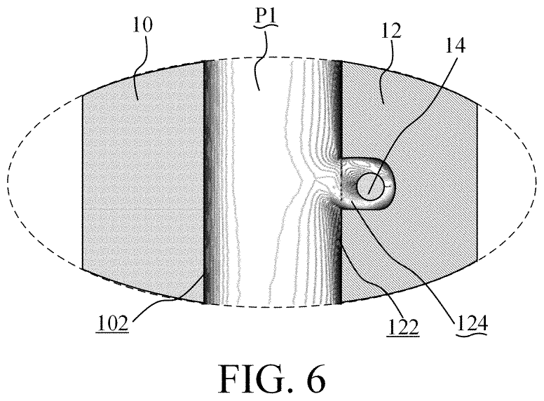

In one embodiment, the cross-section of each groove 124 can exhibit triangular (as shown in FIG. 2, the base of which is located at the second surface 122), trapezoid (the long base of which is located at the second surface 122), a groove with an arc-shaped bottom is (referring to FIG. 6), etc. FIG. 6 is a partial enlarged view of a flow field simulation analysis diagram of another example of the electrostatic dust collection apparatus 1 according to the first preferred embodiment of the invention. In the flow field simulation analysis case of FIG. 6, the width of the air passage P1 is 5 mm. The width of the gas flow channel P1 is 5 mm. The local area shown in FIG. 6 is marked with the ellipse area with a dotted line similarly as shown in FIG. 2. In FIG. 6, the bottom of the groove 124 is arc-shaped, and the included angle θ1 between the second surface 122 of the insulative bearing member 12 and the sidewall of each groove 124 is 270 degrees. Likewise, the flow field simulation analysis diagram of FIG. 6 confirms that the air flow in the grooves 124 of the insulative bearing member 12 is in a stagnant state. Thereby, the plurality of discharge electrodes 14 can reduce from being fouled by suspended particles.

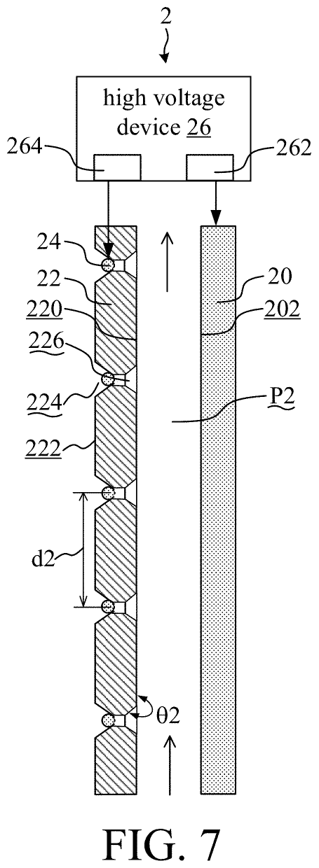

Referring to FIG. 7, FIG. 7 schematically shows an electrostatic dust collection apparatus 2 according to the second preferred embodiment of the invention with a partial cross-sectional view and a functional block diagram of some device.

As shown in FIG. 7, the electrostatic dust collection apparatus 2 according to the second preferred embodiment of the invention includes a sheet collection electrode 20, an insulative bearing member 22, a plurality of discharge electrodes 24 and a high voltage device 26.

The sheet collection electrode 20 has a first surface 202 formed into a plane or an arc surface. In the example shown in FIG. 7, the first surface 202 of the sheet collection electrode 20 is a plane.

The insulative bearing member 22 has a second surface 220, a third surface 222 opposite to the second surface 220 and a plurality of grooves 224 formed on the third surface 222 and a plurality of through holes 226 formed on the second surface 220. The plurality of grooves 224 are formed across the third surface 222 of the insulative bearing member 22. The plurality of grooves 224 are parallel to one another. The insulative bearing member 22 is disposed so that the second surface 220 of the insulative bearing member 22 faces and is parallel to the first surface 202 of the sheet collection electrode 20. Each through hole 226 corresponds to one of the plurality of grooves 224, and communicates with the corresponding groove 224. In one embodiment, one groove 224 corresponds to some through holes 226.

An air passage P2 is defined between the sheet collection electrode 20 and the insulative bearing member 22. The air passage P2 allows an air to be treated to pass through. In the example shown in FIG. 7, the air inlet of the air passage P2 is located at the bottom of the electrostatic dust collection apparatus 2 according to the invention, and the air outlet of the gas flow channel P2 is located at the top of the electrostatic dust collection apparatus w according to the invention. The arrows marked in the air passage P2 represent the direction of air flow.

Each discharge electrode 24 corresponds to one of the grooves 224, and is disposed in the corresponding groove 224.

In one embodiment, each discharge electrode 24 is a metal wire, e.g., stainless steel wire, copper wire, tungsten wire, etc. Compared with the electrostatic dust collection apparatus of the prior art, obviously, the electrostatic dust collection apparatus 2 according to the second preferred embodiment of the invention has a simple structure of the discharge electrode 24 and low manufacturing cost.

The high voltage device 26 has a ground terminal 262 and a discharge terminal 264. The ground terminal 262 of the high voltage device 26 is electrically connected to the sheet collection electrode 20. The discharge terminal 264 of the high voltage device 26 is electrically connected to the plurality of discharge electrodes 24 such that a potential difference exists between the sheet collection electrode 20 and the plurality of discharge electrodes 24. The plurality of discharge electrodes 24 charge a plurality of suspended particles in the air to be treated. The sheet collection electrode 20 collects the plurality of charged suspended particles.

Similarly, the electrostatic dust collection apparatus 2 according to the second preferred embodiment of the invention is created based on the boundary layer effect of fluid. Regarding the boundary layer effect of the fluid, the fluid is affected by the viscous force and will form a thin boundary layer at the edge of the device or member. Within the thin boundary layer, the flow velocity at the fixed surface is zero, and the flow velocity increases further from the edge of the device or member.

In one embodiment, the sides of the plurality of through holes 226 corresponding to the same groove 224 adjacent to the second surface 220 of the insulative bearing member 22 can be connected in series. Thereby, the insulative bearing member 22 can still maintain a certain strength, and the internal air flow in all of the through holes 226 can be in a stagnant state. The parts of the plurality of polarized electrodes 24 exposed to all of the through holes 226 can be reduced from being contaminated by suspended particles.

In one embodiment, also as shown in FIG. 7, a distance d2 between two adjacent grooves 224 in the plurality of grooves 224 ranges from 1 mm to 20 mm. The distance d2 between two adjacent grooves 224 in the plurality of grooves 224 also represents the distance between two adjacent discharge electrodes 24 in the plurality of discharge electrodes 24. The smaller the distance d2 between the two adjacent grooves 224, the higher the distribution density of the discharge electrodes 24, and the increase of the spatial ionization region of the air passage P2.

In one embodiment, an included angle θ2 between the second surface 220 of the insulative bearing member 22 and a sidewall of each groove 224 ranges from 90 degrees to 335 degrees.

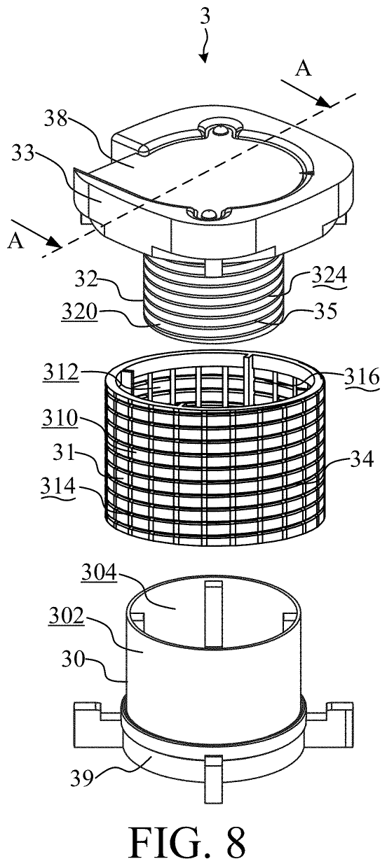

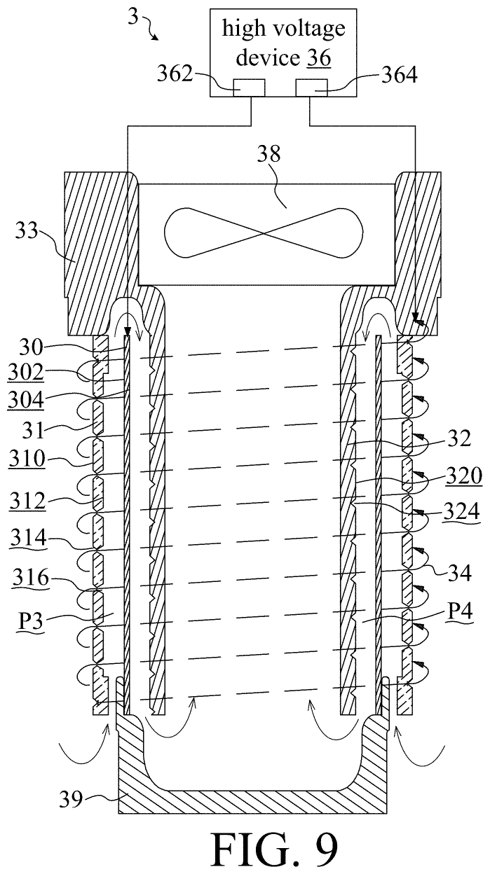

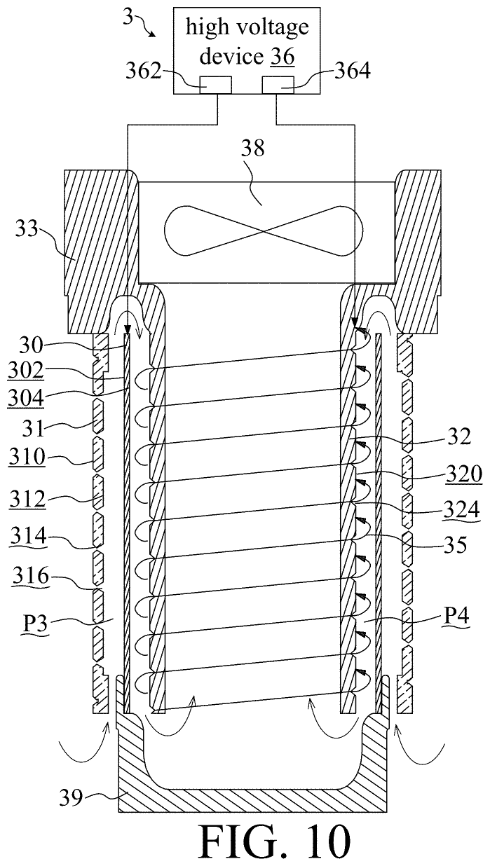

Referring to FIG. 8, FIG. 9 and FIG. 10, those drawings schematically illustrate an air purifier 3 according to the third preferred embodiment of the invention. FIG. 8 schematically shows the air purifier 3 according to the third preferred embodiment of the invention with an explosive view of devices and members. FIG. 9 is a cross-sectional view taken along line A-A of the air purifier 3 shown in FIG. 8 after being assembled. FIG. 10 is another cross-sectional view taken along line A-A of the air purifier 3 shown in FIG. 8 after being assembled.

As shown in FIG. 8, FIG. 9 and FIG. 10, the air purifier 3 according to the third preferred embodiment of the invention includes a tubular collection electrode 30, an insulative outer tubular bearing member 31, an insulative inner tubular bearing member 32, a connecting member 33, an outer discharge electrode 34, an inner discharge electrode 35, and a high voltage device 36.

The tubular collection electrode 30 has a first outer surface 302 and a first inner surface 304.

The insulative outer tubular bearing member 31 has a second outer surface 310, a second inner surface 312, a first groove 314 formed on the second outer surface 310 and a plurality of through holes 316 formed on the second inner surface 312. The first groove 314 extending helically on the second outer surface 310 of the insulative outer tubular bearing member 31. The tubular collection electrode 30 is disposed in the insulative outer tubular bearing member 31 so that the second inner surface 312 of the insulative outer tubular bearing member 31 faces and is parallel to the first outer surface 302 of the tubular collection electrode 30. Each through hole 316 communicates with the first groove 314. A first air passage P3 is defined between the tubular collection electrode 30 and the insulative outer tubular bearing member 31. In the example shown in FIG. 9 and FIG. 10, the air inlet of the first air passage P3 is located at the bottoms of the insulative outer tubular bearing member 31 and the tubular collection electrode 30, and the air outlet of the first air passage P3 is located at the tops of the insulative outer tubular bearing member 31 and the tubular collection electrode 30.

The insulative inner tubular bearing member 32 has a third outer surface 320 and a second groove 322 formed on the third outer surface 320. The second groove 322 extending helically on the third outer surface 320 of the insulative inner tubular bearing member 32. The insulative inner tubular bearing member 32 is disposed in the tubular collection electrode 30 so that the third outer surface 320 of the insulative inner tubular bearing member 32 faces and is parallel to the first inner surface 304 of the tubular collection electrode 30. A second air passage P4 is defined between the tubular collection electrode 30 and the insulative inner tubular bearing member 32. In the example shown in FIG. 9 and FIG. 10, the air inlet of the second air passage P4 is located at the tops of the insulative inner tubular bearing member 32 and the tubular collection electrode 30, and the air outlet of the second air passage P4 is located at the bottoms of the insulative inner tubular bearing member 32 and the tubular collection electrode 30.

As shown in FIG. 9 and FIG. 10, the connecting member 33 connects a first top of the insulative outer tubular bearing member 31 and a second top of the insulative inner tubular bearing member 32 such that a downstream of the first air passage P3 communicates with an upstream of the second air passage P4. The first air passage P3 and the second air passage P4 allow an air to be treated to pass through. The arrows marked in the first air passage P3 and the second air passage P4 represent the direction of air flow.

As shown in FIG. 8 and FIG. 9, the outer discharge electrode 34 is disposed in the first groove 314, and extends along the first groove 314. For the convenience of description, in FIG. 9, the outer discharge electrode 34 is only shown as a winding track, and the inner discharge electrode 35 is not shown, so as to clearly show the winding track of the outer discharge electrode 34.

As shown in FIG. 8 and FIG. 10, the inner discharge electrode 35 is disposed in the second groove 322, and extends along the second groove 322. For the convenience of description, in FIG. 10, the inner discharge electrode 35 is only shown as a winding track, and the outer discharge electrode 34 is not shown, so as to clearly show the winding track of the inner discharge electrode 35.

As shown in FIG. 9 and FIG. 10, the high voltage device 36 has a ground terminal 362 and a discharge terminal 364. The ground terminal 362 of the high voltage device 36 is electrically connected to the tubular collection electrode 30. The discharge terminal 364 of the high voltage device 36 is respectively electrically connected to the outer discharge electrode 34 and the inner discharge electrode 35 such that a first potential difference exists between the tubular collection electrode 30 and the outer discharge electrode 34, and a second potential difference exists between the tubular collection electrode 30 and the inner discharge electrode 35. The outer discharge electrode 34 and the inner discharge electrode 35 charge a plurality of suspended particles in the air to be treated. The tubular collection electrode 30 collects the plurality of charged suspended particles. Obviously, the air purifier 3 according to the invention utilizes the whole surface of the tubular collection electrode 30, which facilitates the miniaturization of the air purifier 3.

The tubular collection electrode 30, the insulative inner tubular bearing member 32, the inner discharge electrode 35 and the high voltage device 36 disclosed in the air purifier 3 according to the invention are equivalent to the electrostatic dust collection apparatus 1 according to the first preferred embodiment of the invention. The tubular collection electrode 30, the insulative outer tubular bearing member 31, the outer discharge electrode 34, and the high voltage device 36 disclosed in the air purifier 3 according to the invention are equivalent to the electrostatic dust collection apparatus 2 according to the second preferred embodiment of the invention. The outer discharge electrode 34 and the inner discharge electrode 35 both are a single metal wire, e.g., stainless steel wire, copper wire, tungsten wire, etc. The outer discharge electrode 34 and the inner discharge electrode 35 have a simple structure, and their manufacturing cost is low.

Also as shown in FIG. 8, FIG. 9 and FIG. 10, the air purifier 3 according to the third preferred embodiment of the invention further includes a fan 38 and a base 39. The connecting member 33 also constitutes a bearing seat, and the fan 38 is fixed in the bearing seat. The air suction port of the fan 38 is located in the bearing seat, and communicates with the air outlet at the bottoms of the insulative inner tubular bearing member 32 and the tubular collection electrode 30. The bottom of the tubular collection electrode 30 is disposed on the base 39.

In one embodiment, a first distance d3 between two adjacent sections of the first groove 314 ranges from 1 mm to 20 mm. The first distance d3 also represents the distance between two adjacent turns of the outer discharge electrode 34 been wound. The smaller the first distance d3, the higher the distribution density of the outer discharge electrode 34, and the increase of the spatial ionization region of the first air passage P3. A second distance d4 between two adjacent sections of the second groove 322 ranges from 1 mm to 20 mm. The second distance d3 also represents the distance between two adjacent turns of the inner discharge electrode 35 been wound. The smaller the second distance d4, the higher the distribution density of the inner discharge electrode 35, and the increase of the spatial ionization region of the second air passage P4.

In one embodiment, a first included angle θ3 between the third outer surface 320 of the insulative inner tubular bearing member 32 and a first sidewall of the second groove 322 ranges from 180 degrees to 270 degrees. A second included angle θ4 between the second inner surface 312 of the insulative outer tubular bearing member and a second sidewall of each through hole 316 ranges from 90 degrees to 335 degrees.

In one embodiment, the first top of the insulative outer tubular bearing member 31 and the second top of the insulative inner tubular bearing member 32 can exhibit a circle (as shown in FIG. 8), an ellipse, a rectangle, a triangle, a trapezoid, a polygon with more than 4 sides, a half circle, a half ellipse, or other geometric shape.

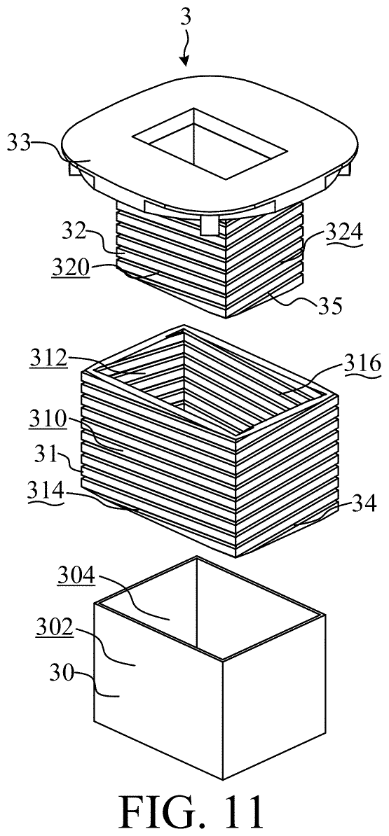

Referring to FIG. 11, FIG. 11 schematically illustrates a modification of the air purifier 3 according to the third preferred embodiment of the invention with an explosive view of devices and members. Obviously, the tops of the tubular collection electrode 30, the insulative outer tubular bearing member 31 and the insulative inner tubular bearing member 32 all exhibit a rectangle. The devices and members in FIG. 11 identical to those shown in FIG. 8 are given the same numerical notations, and will be not described in detail herein. Due to the structure and arrangement of the collection electrode and the polarizing electrode, the air purifier of the prior art has its appearance limited to the design of a cube or a cylinder. The appearance design of the air purifier 3 according to the third preferred embodiment of the invention can have more choices to enhance the overall aesthetic feeling.

Table 1 lists the test results of the interception rate of suspended particles (PM2.5) of the air purifier according to the invention for different distances between two adjacent turns of the discharge electrodes and different flow velocities of the air. In this test case, the total length of the air passage of the air purifier according to the invention is 5 cm, the width of the air passage is 5 mm, the discharge electrodes are electrically connected to the high voltage device of 5 kV, and the original concentration of the suspended particles (PM2.5) of the air to be treated is 10,000 particles/m³.

TABLE 1

velocity

| distance | 1 m/s | 2 m/s |
|---|---|---|
| 10 mm | 62.4% | 25.4% |
| 7 mm | 100% | 31.8% |
| 5 mm | 100% | 100% |

The results listed in Table 1 confirm that the interception rate of suspended particles (PM2.5) of the air purifier according to the invention is up to 100% under the condition of narrower distances between two adjacent turns of the discharge electrodes and lower flow velocities of the air.

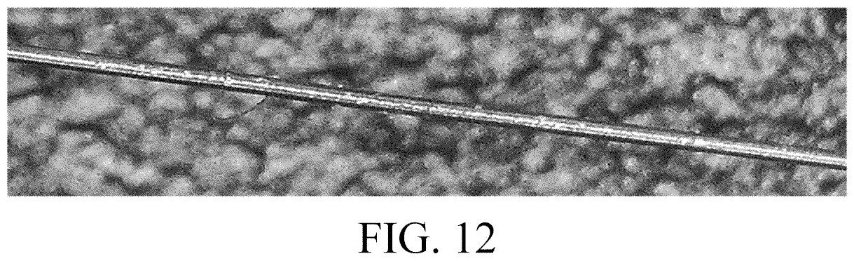

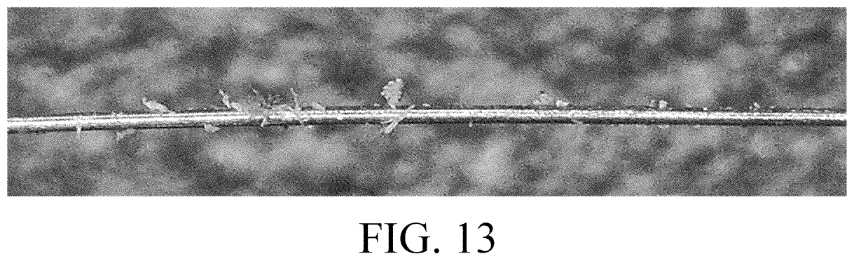

Referring to FIG. 12 and FIG. 13, FIG. 12 is a photograph of the appearance of the discharge electrode of the electrostatic dust collection apparatus according to the invention after operating for 1000 hrs. In contrast, FIG. 13 is a photograph of the appearance of the discharge electrode of the electrostatic dust collection apparatus of the prior art in which the discharge electrode is disposed in the air passage after operating for 24 hrs.

The photograph of FIG. 12 confirms that the discharge electrode disposed in the groove of the electrostatic dust collection apparatus according to the invention is in a stagnant state due to airflow, and the discharge electrode will not be contaminated by suspended particles even after long-term operation. On the contrary, the photograph of FIG. 13 confirms that the prior art electrostatic dust collection apparatus disposes the discharge electrode in the air passage, and after a short time of operation, the discharge electrode is fouled by the suspended particles.

With detailed description of the invention above, it is clear that the electrostatic dust collection apparatus according to the invention can prevent the contamination of the overall polarized electrode, and the overall manufacturing cost of the electrostatic dust collection apparatus is low. The air purifier according to the invention utilizes the whole surface of the collection electrode, which is beneficial to its miniaturization.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An electrostatic dust collection apparatus, comprising:
a sheet collection electrode, having a first surface formed into a plane or an arc surface;
an insulative bearing member, having a second surface and a plurality of grooves formed on the second surface, the plurality of grooves being formed across the second surface, the plurality of grooves being parallel to one another, the insulative bearing member being disposed so that the second surface of the insulative bearing member faces and is parallel to the first surface of the sheet collection electrode, wherein an air passage is defined between the sheet collection electrode and the insulative bearing member, and allows an air to be treated to pass through;
a plurality of discharge electrodes, each discharge electrode corresponding to one of the grooves, and being disposed in the corresponding groove; and
a high voltage device, having a ground terminal and a discharge terminal, the ground terminal being electrically connected to the sheet collection electrode, the discharge terminal being electrically connected to the plurality of discharge electrodes such that a potential difference exists between the sheet collection electrode and the plurality of discharge electrodes, wherein the plurality of discharge electrodes charge a plurality of suspended particles in the air to be treated, and the sheet collection electrode collects the plurality of charged suspended particles.

2. The electrostatic dust collection apparatus of claim 1, wherein a distance between two adjacent grooves in the plurality of grooves ranges from 1 mm to 20 mm.

3. The electrostatic dust collection apparatus of claim 2, wherein an included angle between the second surface and a sidewall of each groove ranges from 90 degrees to 335 degrees.

4. An electrostatic dust collection apparatus, comprising:
a sheet collection electrode, having a first surface formed into a plane or an arc surface;
an insulative bearing member, having a second surface, a third surface opposite to the second surface and a plurality of grooves formed on the third surface and a plurality of through holes formed on the second surface, the plurality of grooves being formed across the third surface, the plurality of grooves being parallel to one another, the insulative bearing member being disposed so that the second surface of the insulative bearing member faces and is parallel to the first surface of the sheet collection electrode, each through hole corresponding to one of the plurality of grooves and communicating with the corresponding groove, wherein an air passage is defined between the sheet collection electrode and the insulative bearing member, and allows an air to be treated to pass through;
a plurality of discharge electrodes, each discharge electrode corresponding to one of the grooves, and being disposed in the corresponding groove; and
a high voltage device, having a ground terminal and a discharge terminal, the ground terminal being electrically connected to the sheet collection electrode, the discharge terminal being electrically connected to the plurality of discharge electrodes such that a potential difference exists between the sheet collection electrode and the plurality of discharge electrodes, wherein the plurality of discharge electrodes charge a plurality of suspended particles in the air to be treated, and the sheet collection electrode collects the plurality of charged suspended particles.

5. The electrostatic dust collection apparatus of claim 4, wherein a distance between two adjacent grooves in the plurality of grooves ranges from 1 mm to 20 mm.

6. The electrostatic dust collection apparatus of claim 5, wherein an included angle between the second surface and a sidewall of each through hole ranges from 90 degrees to 335 degrees.

7. An air purifier, comprising:
a tubular collection electrode, having a first outer surface and a first inner surface;
an insulative outer tubular bearing member, having a second outer surface, a second inner surface, a first groove formed on the second outer surface and a plurality of through holes formed on the second inner surface, the first groove extending helically on the second outer surface, the tubular collection electrode being disposed in the insulative outer tubular bearing member so that the second inner surface of the insulative outer tubular bearing member faces and is parallel to the first outer surface of the tubular collection electrode, each through hole communicating with the first groove, wherein a first air passage is defined between the tubular collection electrode and the insulative outer tubular bearing member;
an insulative inner tubular bearing member, having a third outer surface and a second groove formed on the third outer surface, the second groove extending helically on the third outer surface, the insulative inner tubular bearing member being disposed in the tubular collection electrode so that the third outer surface of the insulative inner tubular bearing member faces and is parallel to the first inner surface of the tubular collection electrode, wherein a second air passage is defined between the tubular collection electrode and the insulative inner tubular bearing member;
a connecting member, connecting a first top of the insulative outer tubular bearing member and a second top of the insulative inner tubular bearing member such that a downstream of the first air passage communicates with an upstream of the second air passage, wherein the first air passage and the second air passage allow an air to be treated to pass through;
an outer discharge electrode, being disposed in the first groove and extending along the first groove;
an inner discharge electrode, being disposed in the second groove and extending along the second groove; and
a high voltage device, having a ground terminal and a discharge terminal, the ground terminal being electrically connected to the tubular collection electrode, the discharge terminal being respectively electrically connected to the outer discharge electrode and the inner discharge electrode such that a first potential difference exists between the tubular collection electrode and the outer discharge electrode, and a second potential difference exists between the tubular collection electrode and the inner discharge electrode, wherein the outer discharge electrode and the inner discharge electrode charge a plurality of suspended particles in the air to be treated, and the tubular collection electrode collects the plurality of charged suspended particles.

8. The air purifier of claim 7, wherein a first distance between two adjacent first groove sections in the first groove ranges from 1 mm to 20 mm, and a second distance between two adjacent second groove sections in the second groove ranges from 1 mm to 20 mm.

9. The air purifier of claim 8, wherein a first included angle between the third outer surface and a first sidewall of the second groove ranges from 180 degrees to 270 degrees, and a second included angle between the second inner surface and a second sidewall of each through hole ranges from 90 degrees to 335 degrees.

10. The air purifier of claim 9, wherein the first top of the insulative outer tubular bearing member and the second top of insulative inner tubular bearing member exhibit one selected from the group consisting of a circle, an ellipse, a rectangle, a triangle, a trapezoid, a polygon with more than 4 sides, a half circle and a half ellipse.
